(19) United States
(12) Patent Application Publication
(10) Pub. No.: US 2010/0290637 A1
(43) Pub. Date: Nov. 18, 2010

(54) DEVICE FOR THE PLAYBACK OF SOUNDS

(75) Inventor: Noa Lerner, Berlin (DE)

Correspondence Address: SUGHRUE MION, PLLC, 2100 PENNSYLVANIA AVENUE, N.W., SUITE 800, WASHINGTON, DC, 20037, US

(73) Assignee: UNIVERSITAI DER KUNSTE BERLIN INSTITUT FUR PRODUKT -UND PROZESSGESTALTUNG, Berlin (DE)

(21) Appl. No.: 12/669,647

(22) PCT Filed: Jan. 25, 2008
(86) PCT No.: PCT/EP08/00590

§ 371 Date: Jun. 21, 2010

Related U.S. Application Data
(60) Provisional application No. 60/978,771, filed on Oct. 10, 2007.

(30) Foreign Application Priority Data
Jul. 18, 2007 (DE) 10 2007 033 52.4

(51) Int. Cl. H04R 1/10

(52) U.S. Cl. 381/74

(57) ABSTRACT

The invention relates to a device (100) for the playback of sounds, comprising a sound playback means (110), a speaker (130), and a power supply unit (120) for providing electrical energy to the sound playback means (110) and the speaker (130), wherein the sound playback means (110), the speaker (130), and the power supply unit (120) are accommodated in a molded body (140), and wherein the molded body (140) is formed such that it is held in the human ear without any further implement.

The present invention relates to an apparatus for sound reproduction, particularly for the reproduction of music.

Sound reproduction apparatuses are known both as static appliances, such as stereo installations, or as portable appliances, such as portable CD players or MP3 players. Many of the portable appliances have a larger or smaller housing, which accommodates a player together with a power supply, and also headphones which are connected to said housing. This arrangement comprising housing and headphones forces a user to carry the housing in his hand or in a pocket in his clothing, for example. This may be inconvenient and may also carry the risk that the appliance slips out of the pocket.

Against this background, the present invention provides an apparatus for sound reproduction as claimed in claim 1. Further aspects, details, advantages and features of the present invention can be found in the subclaims, in the description and in the appended drawings.

In line with one exemplary embodiment, the invention provides an apparatus for sound reproduction which comprises a sound reproduction means, a loudspeaker and a power supply unit for providing electrical power for the sound reproduction means and for the loudspeaker, wherein the sound reproduction means, the loudspeaker and the power supply unit are held in a shaped body, and wherein the shaped body is shaped such that it stays in a human ear without further aids.

The apparatus for sound reproduction based on the above exemplary embodiment can easily be put into the ear by a user and stays there on account of the shape of the shaped body. Since the sound reproduction means together with the loudspeaker and the power supply is held in the shaped body, there is no need to accommodate a player elsewhere. In this case, it should be noted that the shaped body is shaped such that it stays in a human ear without further aids. In this context, it should be noted that there is a difference here between staying “in an ear”, i.e. essentially within the auricle, and staying “on an ear”. This is because staying on an ear may also involve portions of the apparatus being clamped behind the ear, as provided in the case of certain hearing aids or glasses with an integrated hearing aid. A person skilled in the art will therefore understand that apparatuses which stay on an ear are different than apparatuses based on the exemplary embodiments, which stay in an ear. In particular, the exemplary embodiments of the present invention involve the shaped body being arranged essentially within the auricle or partially at or in the entrance to the ear canal. In this case, a person skilled in the art will make allowance for the fact that the shape of the apparatus can be customized to the shape and size of an average ear. In addition, it is also possible to provide sound reproduction apparatuses in various standard sizes, e.g. for children and adults. It goes without saying that it is also possible to produce made-to-measure items for individual people, with the shape of the shaped body being individually customized.

In line with another exemplary embodiment, such an apparatus can be used in a system for conveying information. In such a system, the apparatus for sound reproduction has an antenna which is suitable for receiving electromagnetic radiation. In addition, the system comprises a transmission device for emitting electromagnetic radiation, wherein the transmission device has a directional radiation characteristic. The apparatus for sound reproduction is set up to reproduce a piece of sound information when it receives the electromagnetic radiation emitted by the transmission device.

By way of example, such a system can be used in museums in order to replace the audio guides used to date. The transmission device could thus be oriented to a particular painting, for example. As soon as a user enters the radiation field of the directional antenna, the sound reproduction apparatus is activated and reproduces a predetermined explanation relating to the painting.

Exemplary embodiments of the present invention will now be explained with reference to the appended drawings, in which:

FIG. 1 shows a sound reproduction apparatus based on an exemplary embodiment.

FIG. 2 shows the use of the sound reproduction apparatus by a user.

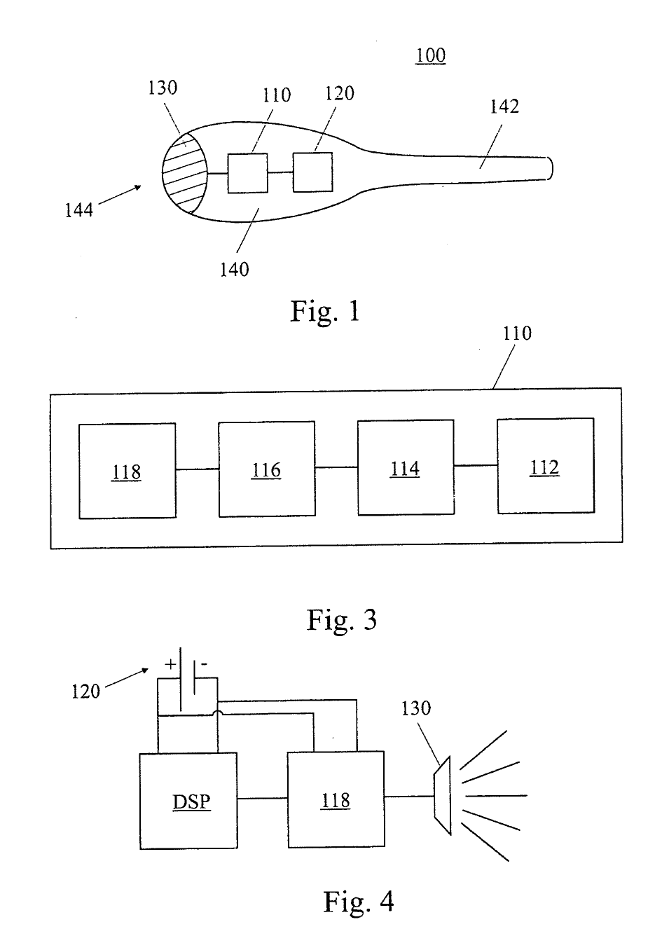

FIG. 3 shows a schematic view of a sound reproduction means based on an exemplary embodiment.

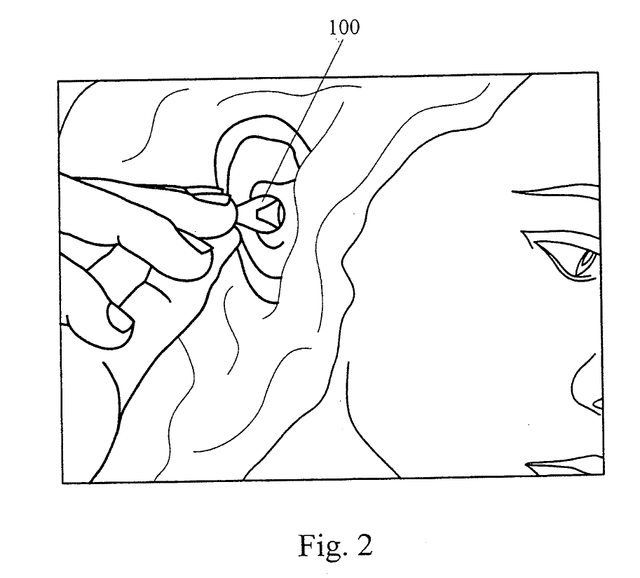

FIG. 4 shows a schematic circuit diagram of the sound reproduction apparatus.

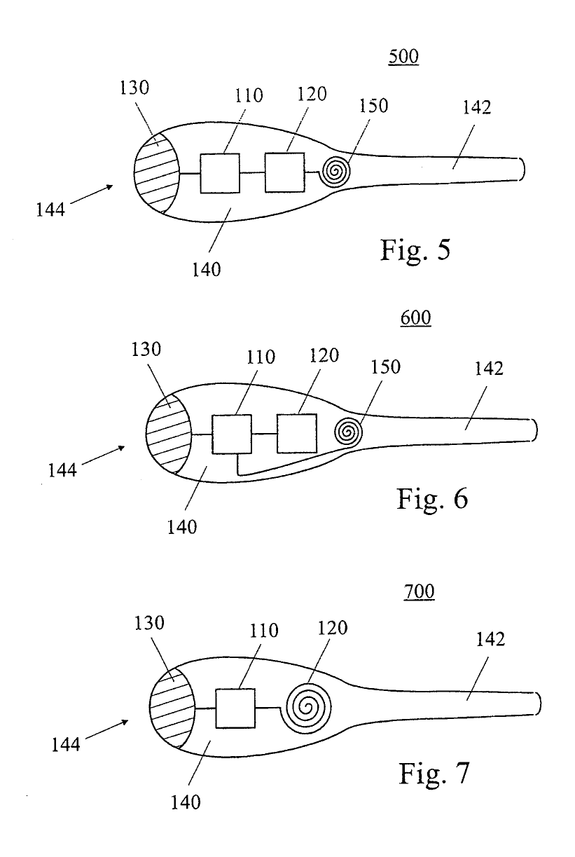

FIG. 5 shows a sound reproduction apparatus based on a further exemplary embodiment.

FIG. 6 shows a sound reproduction apparatus based on yet a further exemplary embodiment.

FIG. 7 shows a sound reproduction apparatus based on another exemplary embodiment.

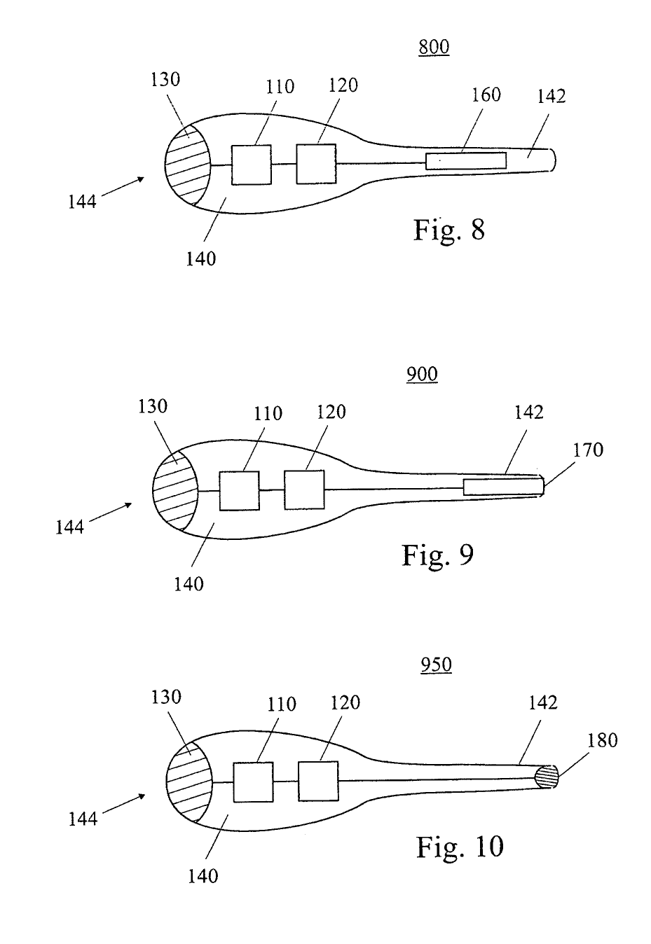

FIG. 8 shows a sound reproduction apparatus based on yet another exemplary embodiment.

FIG. 9 shows a sound reproduction apparatus based on yet a further exemplary embodiment.

FIG. 10 shows a sound reproduction apparatus based on another exemplary embodiment.

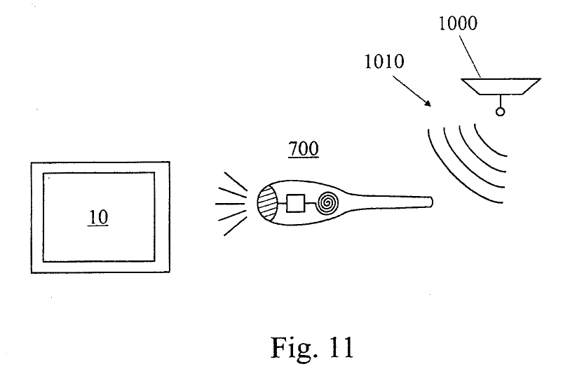

FIG. 11 shows a system for conveying information based on an exemplary embodiment.

FIG. 1 shows a sound reproduction apparatus 100 based on an exemplary embodiment. The apparatus 100 for sound reproduction comprises a sound reproduction means 110, a loudspeaker 130 and a power supply unit 120. The power supply unit 120 can supply the sound reproduction means 110 and the loudspeaker 130 with electrical power. The sound reproduction means 110, the loudspeaker 130 and the power supply unit 120 are held in a shaped body 140. In this case, the shaped body 140 is shaped such that it stays in a human ear without further aids, e.g. by virtue of a matched fit.

The use of the sound reproduction apparatus is shown in FIG. 2. Here, a user holds the shaped body in his fingers and introduces it into his ear. By way of example, the shaped body 140 may be essentially drop-shaped, one end 144 of the shaped body 140 being customized for insertion into the external auditory canal of a human ear. An opposite end 142 may be shaped to be narrower, for example, so that it can easily be held by the fingertips. In particular, the shaped body may be shaped such that the user thereof can arrange it essentially within the auricle and/or also partially at or in the entrance to the ear canal. In this way, the suitable shape ensures that the sound reproduction apparatus 100 is held sufficiently securely. In line with one exemplary embodiment, the shaped body 140 is essentially formed from silicone. Silicone is firstly very skin-friendly and secondly soft, which allows the shaped body to be compressed by the fingers for the purpose of insertion into the auricle. When the shaped body 140 is positioned correctly, it is released and relaxes. In this way, the shaped body 140 is held in the ear by virtue of a matched fit, without the need for further aids. The apparatus 100 for sound reproduction based on the above exemplary embodiment can thus easily be inserted into the ear by the user and stays there on account of the shape of the shaped body. Since the sound reproduction means 110 together with the loudspeaker 130 and the power supply 120 is held in the shaped body 140, there is no need to accommodate a player elsewhere.

As FIG. 1 shows, the loudspeaker 130 is arranged at the end 144 of the shaped body 140 which is customized for insertion into the external auditory canal of the ear. In this way, the sound is routed directly into the ear and scarcely emitted to the outside. By way of example, the loudspeaker 130 may comprise a piezoelectric sound transducer. The sound reproduction means 110 and the loudspeaker 130 are supplied with electrical power by the power supply unit 120. By way of example, the power supply unit 120 may comprise a storage means for electrical power, such as a battery or a storage battery. In this case, the storage means may comprise a lithium battery, a capacitor and/or an electrochemical power source, for example.

The functionality of the sound reproduction means will now be explained with reference to FIG. 3, which shows a schematic view of the sound reproduction means 110 based on an exemplary embodiment. Here, the sound reproduction means 110 comprises a digital sound memory 112 for storing digital sound information. By way of example, the sound information may be stored in the sound memory 112 in MP3 format, in AAC format or in Vorbis format or similar digital formats for storing sound. In this case, the sound memory 112 may be in the form of a read-only memory (ROM) which stores a piece of permanent sound information. However, the sound memory 112 may also be in the form of a read/write memory (RAM), e.g. in the form of ferroelectric memories (FeRAM) or flash memories. The sound memory 112 may comprise just a single song or else a plurality of songs, for example. It is likewise conceivable for the sound memory 112 to store an audio book or portions therefrom. Furthermore, the sound reproduction means 110 comprises a microprocessor 114 which is customized to read the sound information stored in the sound memory 112. In particular, the microprocessor is customized to access the respective memory type and to decode the sound format stored therein. In this case, the microprocessor may be set up such that it can convert various sound formats. In addition, the microprocessor may comprise a function for battery management which performs the battery management for the power supply 120. In addition, the sound reproduction means 110 comprises a digital/analog converter 116 which converts the digital sound signal decoded by the microprocessor 114 into an analog sound signal. Furthermore, the sound reproduction means 110 comprises an amplifier 118 which amplifies the analog signal which is output by the digital/analog converter 116 and outputs it to the loudspeaker 130. In some exemplary embodiments, the sound memory 112, the digital/analog converter 116 and/or the amplifier 118 are in the form of an integrated electronic component. By way of example, the sound reproduction means 110 may be in the form of a digital signal processor (DSP). In this case, all the elements listed above or else just some of them may be integrated on the DSP as desired.

FIG. 4 shows a schematic circuit diagram of the sound reproduction apparatus 100, in which a digital signal processor DSP is used. As described above, the power supply unit provides the DSP and also the separately provided amplifier 118 with electrical power. In the example shown in FIG. 4, the sound memory 112, the decoder/microprocessor 114 and also the digital/analog converter 116 are integrated on the DSP, whereas the amplifier 118 is provided as a separate component. When the power supply 120 supplies the DSP and the amplifier 118 with electrical power, the decoder 114 reads the sound information stored in the sound memory 112 and converts it into a digital sound signal. This digital sound signal is then converted into an analog signal by the digital/analog converter and is output to the amplifier 118. The amplifier 118 amplifies the analog signal sufficiently and outputs it to the loudspeaker 130. The loudspeaker 130 produces an audible signal which corresponds to the stored sound information. In this way, the sound information stored in the sound memory 112 is output to the user of the apparatus 100.

FIG. 5 shows a sound reproduction apparatus 500 based on a further exemplary embodiment. Here, the apparatus 500 comprises an antenna 150 for receiving electromagnetic radiation. In addition, the storage means 120 for electrical power is set up to store the electromagnetic power which has been received via the antenna 150. By way of example, the storage means 120 is in the form of a storage battery which can be recharged wirelessly via the antenna 150. In this case, any suitable electromagnetic radiation, but particularly radio waves and/or microwaves, can be used for the transmission. The antenna 150 is customized to the desired wavelength range. The antenna 150 also has a receiver circuit (not shown) provided for reception. In some exemplary embodiments, the circuit may be in the form of what is known as a transceiver and can therefore allow both reception and transmission. By way of example, the apparatus 500 can be put into a charger which allows wireless charging of the storage battery.

FIG. 6 shows a sound reproduction apparatus 600 based on yet a further exemplary embodiment. Here, the apparatus 600 likewise has an antenna 150. However, the antenna 150 is connected to a sound reproduction means 110 which has a sound memory 112. The sound memory 112 of the sound reproduction means 110 is set up to store sound information which has been transmitted by means of electromagnetic radiation and received by the antenna 150. By way of example, the sound memory 112 may be in the form of a flash memory. It is therefore possible for the sound information transmitted by means of the electromagnetic radiation to be stored in the flash memory 112 and to replace existing sound information, for example. In this way, the sound information which is stored in the sound memory 112 can be replaced wirelessly. In this exemplary embodiment, the sound reproduction apparatus 600 has an internal power supply unit 120, so that it is merely necessary to transmit the sound information by means of the electromagnetic radiation.

FIG. 7 shows a sound reproduction apparatus 700 based on another exemplary embodiment. This sound reproduction apparatus 700 also has an antenna for receiving electromagnetic radiation. In this exemplary embodiment, however, the antenna 150 is used as a power supply unit 120. Hence, sound reproduction is effected by the sound reproduction apparatus 700 only if the antenna 120 can receive electromagnetic radiation on a suitable wavelength. In this way, the sound reproduction can be controlled from outside by the electromagnetic radiation. In this case, the sound reproduction apparatus 700 may be set up such that it merely uses the electromagnetic radiation as a power source and reproduces a piece of sound information which is stored in a sound memory 112. However, it is also possible for the electromagnetic radiation to additionally transmit a piece of sound information to the sound reproduction apparatus 700. In this case, the electromagnetic radiation is used simultaneously for transmitting power and information. In line with one exemplary embodiment, the sound reproduction means 110 of the sound reproduction apparatus 700 is set up to directly reproduce the sound information transmitted by means of the electromagnetic radiation.

FIG. 8 shows a sound reproduction apparatus 800 based on yet another exemplary embodiment. Here, the sound reproduction apparatus 800 also comprises a trip mechanism 160. Operation of the trip mechanism 160 starts and/or terminates the reproduction of sound information by the sound reproduction means 110. In this way, a user of the sound reproduction apparatus 800 can start and/or terminate the sound reproduction according to his wishes or requirements. In line with one exemplary embodiment, the trip mechanism 160 comprises a pressure sensor, which may be in the form of a piezoelectric sensor, in particular. The trip mechanism 160 is arranged at the end 142 of the shaped body 140 which is opposite that end 144 of the shaped body 140 which is customized for insertion into the auditory canal of the ear. In other words, the trip mechanism 160 is situated at the rear end of the sound reproduction apparatus 800 which is held by the fingers upon insertion into the ear and, in the inserted state, protrudes from the external auditory canal or the auricle.

In line with one development, the trip mechanism 160 is in the form of a 5-way joystick. The 5-way joystick 160 allows a user better control of the sound reproduction. If the sound memory 112 stores a plurality of pieces of music, for example, the joystick 160 can be used to navigate in the playlist. In particular, it is possible to fast-forward and rewind and to skip pieces of music in addition to starting and terminating them.

FIG. 9 shows a sound reproduction apparatus 900 based on yet a further exemplary embodiment. In this case, a female connector 170 is arranged at the rear end 142 of the shaped body 140. By way of example, the female connector 170 may be in the form of a 4-pole microjack female connector. The female connector 170 can be used to set up a datalink to an external appliance, for example. This may be a USB connection, for example. In this case, the microchip 114 may have a USB decoder. The USB connection can then be used to store new sound information in the sound memory 112.

FIG. 10 shows a sound reproduction apparatus 950 based on another exemplary embodiment. Here, the apparatus 950 comprises a microphone 180 which can be used to pick up sound information. The sound information picked up by the microphone can be stored in the sound memory 112, for example. In this way, a user can send another person a message using the apparatus 950. In line with another example, the sound information picked up can be reproduced immediately.

In all the exemplary embodiments of the present invention, the sound reproduction means 110, the loudspeaker 130, the power supply unit 120 and/or the sound memory 112 and/or the antenna 150 and/or the trip mechanism 160 may be embedded in the material of the shaped body 140. In particular, the sound reproduction means 110, the loudspeaker 130, the power supply unit 120 and/or the sound memory 112 and/or the antenna 150 and/or the trip mechanism 160 may be formed integrally with the shaped body 160. By way of example, the sound reproduction means 110, the loudspeaker 130, the power supply unit 120 and/or the sound memory 112 and/or the antenna 150 and/or the trip mechanism 160 may be molded in the material of the shaped body 160. To this end, the aforementioned components can be put into a mold during manufacture and then molded with silicone or another suitable material, for example.

A specific type of application for the sound reproduction apparatus based on exemplary embodiments of the present invention is shown in FIG. 11. Here, a system for conveying information based on an exemplary embodiment comprises an apparatus 700 for sound reproduction which has an antenna for receiving electromagnetic radiation. By way of example, the embodiment shown in FIG. 7 is shown here, but all other embodiments of sound reproduction apparatuses with antennas are also suitable. In addition, the system comprises a transmission device 1000 for emitting electromagnetic radiation. The transmission device 1000 has a directional radiation characteristic, i.e. the electromagnetic radiation is not distributed evenly but rather is oriented essentially to a predetermined area. Outside of the predetermined area, the transmitted power of the directional antenna 1000 is too weak to be processed by the sound reproduction device 700. The sound reproduction apparatus 700 is set up to reproduce a piece of sound information when it receives the electromagnetic radiation 1010 emitted by the transmission device. In this way, the sound information is reproduced only when the sound reproduction apparatus 700 is situated in the predetermined area of high transmitted power. Outside of this area, there is no sound be transmitted by means of the electromagnetic radiation 1010 or else may be stored in a sound memory 112 in the apparatus 700. By way of example, in the latter case, the information associated with the picture can be selected for reproduction by means of the transmitted electromagnetic radiation 1010. This can be done by a signature associated with the picture 10, for example, said signature being transmitted to the apparatus 700 by means of the electromagnetic radiation 1010.

The present invention has been explained with reference to exemplary embodiments. These exemplary embodiments should in no way be understood as restricting on the present invention.

1. An apparatus (100) for sound reproduction, comprising a sound reproduction means (110), a loudspeaker (130) and a power supply unit (120) for providing electrical power for the sound reproduction means (110) and for the loudspeaker (130), wherein the sound reproduction means (110), the loudspeaker (130) and the power supply unit (120) are held in a shaped body (140), and wherein the shaped body (140) is shaped such that it stays in a human ear without further aids.

2. The apparatus as claimed in claim 1, wherein the shaped body (140) is essentially drop-shaped, and wherein one end (144) of the shaped body (140) is customized for insertion into the external auditory canal of the ear.

3. The apparatus as claimed in claim 1, wherein the shaped body (140) essentially comprises silicone.

4. The apparatus as claimed in claim 1, wherein the loudspeaker (130) is arranged at an end (144) of the shaped body (140) which is customized for insertion into the external auditory canal of the ear.

5. The apparatus as claimed in claim 1, wherein the loudspeaker (130) comprises a piezoelectric sound transducer.

6. The apparatus as claimed in claim 1, also comprising a digital sound memory (112) for storing digital sound information.

7. The apparatus as claimed in claim 6, wherein the sound memory (112) is in the form of a read-only memory.

8. The apparatus as claimed in claim 6, wherein the sound memory (112) is in the form of a ferroelectric memory or in the form of a flash memory.

9. The apparatus as claimed in claim 6, wherein the sound reproduction means (110) comprises a microprocessor (114) which is customized to read the sound information stored in the sound memory (112).

10. The apparatus as claimed in claim 1, wherein the sound reproduction means (110) comprises a digital/analog converter (118) which is customized to convert digital sound information into an analog signal.

11. The apparatus as claimed in claim 10, wherein the sound reproduction means (110) also comprises an amplifier (118) for amplifying the analog signal.

12. The apparatus as claimed claim 1, wherein the sound reproduction means (110) and/or the sound memory (112) and/or the digital/analog converter (116) and/or the amplifier (118) are in the form of an integrated electronic component.

13. The apparatus as claimed in claim 12, wherein the integrated electronic component is a digital signal processor (DSP).

14. The apparatus as claimed in claim 1, wherein the power supply unit (120) comprises a storage means for electrical power.

15. The apparatus as claimed in claim 14, wherein the storage means comprises a battery or a storage battery.

16. The apparatus as claimed in claim 1, also comprising an antenna (150) for receiving electromagnetic radiation (1010).

17. The apparatus as claimed in claim 14, wherein the storage means for electrical power is set up to store electromagnetic power which has been received via the antenna (150).

18. The apparatus as claimed in claim 16, wherein the sound memory (112) is set up to store sound information transmitted by means of electromagnetic radiation (1010) which can be received via the antenna (150).

19. The apparatus as claimed in claim 16, wherein the sound reproduction means (112) is set up to directly reproduce sound information transmitted by means of electromagnetic radiation (1010) which can be received via the antenna (150).

20. The apparatus as claimed in claim 1, also comprising a trip mechanism (160), the operation of which initiates and/or terminates reproduction of sound information by the sound reproduction means (110).

21. The apparatus as claimed in claim 20, wherein the trip mechanism (160) comprises a pressure sensor.

23. The apparatus as claimed in claim 20, wherein the trip mechanism (160) comprises a joystick.

24. The apparatus as claimed in claim 20, wherein the trip mechanism (160) is arranged at an end (142) of the shaped body (140) which is arranged opposite that end (144) of the shaped body (140) which is customized for insertion into the auditory canal of the ear.

25. The apparatus as claimed in claim 1, also comprising a female connector (170).

26. The apparatus as claimed in claim 25, wherein the female connector (170) is a four-pole microjack female connector.

27. The apparatus as claimed in claim 1, also comprising a microphone (180) which can be used to pick up sound information and to transmit it to the sound reproduction means (110) and/or to the sound memory (112).

28. The apparatus as claimed in claim 1, wherein the sound reproduction means (110), the loudspeaker (130), the power supply unit (120) and/or the sound memory (112) and/or the antenna (150) and/or the trip mechanism (160) and/or the female connector (170) and/or the microphone (180) are embedded in the material of the shaped body (140).

29. The apparatus as claimed in claim 28, wherein the sound reproduction means (110), the loudspeaker (130), the power supply unit (120) and/or the sound memory (112) and/or the antenna (150) and/or the trip mechanism (160) and/or the female connector (170) and/or the microphone (180) are formed integrally with the shaped body (160).

30. The apparatus as claimed in claim 28, wherein the sound reproduction means (110), the loudspeaker (130), the power supply unit (120) and/or the sound memory (112) and/or the antenna (150) and/or the trip mechanism (160) and/or the female connector (170) and/or the microphone (180) are molded in the material of the shaped body (160).

31. A system for conveying information, comprising an apparatus (500, 600, 700) for sound reproduction as claimed in claim 16 and a transmission device (1000) for emitting electromagnetic radiation, wherein the transmission device (1000) has a directional radiation characteristic and the apparatus for sound reproduction is set up to reproduce a piece of sound information when it receives the electromagnetic radiation (1010) emitted by the transmission device.

32. The system as claimed in claim 31, wherein the sound information to be reproduced by the apparatus (500, 600, 700) is transmitted by means of the electromagnetic radiation (1010).

33. The system as claimed in claim 31, wherein the sound information to be reproduced by the apparatus (500, 600, 700) is stored in a sound memory (112) in the apparatus and is selected for reproduction by means of the transmitted electromagnetic radiation (1010).
